(19) United States
(12) Patent Application Publication
(10) Pub. No.: US 2015/0131116 A1
(43) Pub. Date: May 14, 2015

(54) INSPECTION APPARATUS, IMAGE FORMING APPARATUS, INSPECTION METHOD, AND COMPUTER-READABLE STORAGE MEDIUM

(71) Applicant: Yoshinori Sochi, Tokyo (JP)

(72) Inventor: Yoshinori Sochi, Tokyo (JP)

(73) Assignee: RICOH COMPANY, LTD., Tokyo (JP)

(21) Appl. No.: 14/535,272

(22) Filed: Nov. 6, 2014

(30) Foreign Application Priority Data
Nov. 11, 2013 (JP) 2013233254

(51) Int. Cl. H04N 1/00

(52) U.S. Cl. CPC H04N 1/00925; H04N 1/00005; H04N 1/00037; H04N 1/00045; H04N 1/00082; H04N 1/00039; H04N 2201/0005; H04N 2201/0082; H04N 2201/0081
USPC 358/1.14

(57) ABSTRACT

The present invention provides an inspection apparatus including a pause control unit which, when a defect is detected in a page of a printed product while the printed product is continuously printed, causes printing to pause, a predictor unit which, when printing is paused, predicts whether a defect will be detected again in restarting printing by using a master image of a not-yet-printed page, a master image of the defect-detected page, and a predetermined defect prediction criterion, and a resumption control unit which permits to restart printing the defect-detected page and pages following the defect-detected page if the predictor unit predicts that a defect will not be detected again in restarting printing, and prohibits from restarting printing if the predictor unit predicts that a defect will be detected again.

### CROSS-REFERENCE TO RELATED APPLICATIONS

The present application claims priority to and incorporates by reference the entire contents of Japanese Patent Application No. 2013-233254 filed in Japan on Nov. 11, 2013.

### BACKGROUND OF THE INVENTION

1. Field of the Invention

The present invention relates to inspection apparatuses, inspection methods, image forming apparatuses, and computer-readable storage media configured to inspect printed products.

2. Description of the Related Art

A technology for inspecting a printed product by detecting a defect therein by comparing a scanned image obtained by scanning the printed product with a master image corresponding to the printed product is conventionally known. Typically, when a defect is detected in a page of a printed product containing multiple pages while the printed product is continuously printed, the defect-detected page and already-printed pages that follow the defect-detected page of the printed product are discarded, and printing is restarted from the defect-detected page. However, this approach is disadvantageous in that, if a similar abnormal condition repeatedly recurs for some reason, a same defect is to be detected in a printed product obtained by restarting printing each time abnormal condition recurs, resulting in waste of a large amount of printing paper and coloring materials.

An example of a technology for reducing such waste of printing paper and coloring materials which can occur in restarting printing is disclosed in Japanese Laid-open Patent Application No. 2012-11769. According to this technology, when printing is restarted, a predetermined number of sheets is printed first. After it is determined that the resultant printed product has no defect, printing of remaining subsequent sheets is started.

However, the technology described in Japanese Laid-open Patent Application No. 2012-11769 is disadvantageous in that, in a situation where a same defect is repeatedly detected each time a printed product of a predetermined number of sheets is produced, waste of printing paper and coloring materials can repeatedly occur, which means failure in effective reduction of waste of printing paper and coloring materials.

Under the circumstances, there is a need for inspection apparatuses, inspection methods, image forming apparatuses, and computer-readable storage media configured to reduce waste of printing paper and coloring materials which can occur in restarting printing.

It is an object of the present invention to at least partially solve the problem in the conventional technology.

### SUMMARY OF THE INVENTION

It is an object of the present invention to at least partially solve the problems in the conventional technology. The present invention provides an inspection apparatus for inspecting a printed product. The inspection apparatus includes a generating unit configured to generate master images corresponding to the printed product containing multiple pages before the printed product is printed; an inspection unit configured to inspect the printed product for a defect by comparing scanned images obtained by scanning the printed product with the master images; a pause control unit configured to, when the inspection unit detects a defect in a page of the printed product while the printed product is continuously printed, cause printing to pause; a predictor unit configured to, when the pause control unit causes printing to pause, predict whether or not a defect will be detected again in restarting printing by using one master image of the master images generated by the generating unit, the one master image being of a not-yet-printed page, a master image of the page where the defect is detected by the inspection unit, and a predetermined defect prediction criterion; and a resumption control unit configured to permit to restart printing the page where the defect is detected by the inspection unit and pages following the defect-detected page if the predictor unit predicts that a defect will not be detected again in restarting printing, and prohibit from restarting printing the page where the defect is detected by the inspection unit and the pages following the defect-detected page if the predictor unit predicts that a defect will be detected again in restarting printing. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example configuration of an image forming system including an inspection apparatus according to an embodiment of the present invention;

FIG. 2 is a block diagram illustrating an example configuration of a printer apparatus and the inspection apparatus;

FIG. 3 is a block diagram illustrating an example functional configuration of a print-restart control unit of the inspection apparatus;

FIG. 4 is a flowchart illustrating an example of processing procedure for a system control unit of the printer apparatus during normal printing;

FIG. 5 is a flowchart illustrating an example of processing procedure for a system control unit of the inspection apparatus during normal printing;

FIG. 6 is a schematic diagram illustrating a specific example of operation of the inspection apparatus;

FIG. 7A is a sequence diagram illustrating the specific example of operation of the inspection apparatus;

FIG. 7B is a sequence diagram, continued from FIG. 7A, illustrating the specific example of operation of the inspection apparatus;

FIG. 8 is a table of master images, scanned images, and inspection results put into categories on a per-page-basis;

FIG. 9 is a flowchart illustrating an example of processing procedure for the print-restart control unit of the inspection apparatus;

FIG. 10 is a flowchart illustrating an example of processing procedure for a predictor unit which uses an image similarity criterion as a defect prediction criterion;

FIGS. 11A and 11B are schematic diagrams illustrating specific example situations in each of which it is predicted, by the image similarity criterion, that a defect will be detected again in restarting printing;

FIG. 12 is a flowchart illustrating an example of processing procedure for the predictor unit which uses a toner-consumption-ratio similarity criterion as the defect prediction criterion;

FIGS. 13A and 13B are schematic diagrams illustrating specific example situations in each of which it is predicted, by the toner-consumption-ratio similarity criterion, that a defect will be detected again in restarting printing;

FIG. 14 is a schematic diagram illustrating another example situation where it is predicted, by the toner-consumption-ratio similarity criterion, that a defect will be detected again in restarting printing;

FIG. 15 is a table describing an example of an image feature criterion;

FIG. 16 is a flowchart illustrating an example of processing procedure for the predictor unit which uses the image feature criterion as the defect prediction criterion;

FIGS. 17A and 17B are schematic diagrams illustrating specific examples of processing performed by the predictor unit in a situation where a type of a defect detected by an inspection unit is C (cyan)color unevenness;

FIG. 18 is a schematic diagram illustrating a specific example of processing performed by the predictor unit in a situation where a type of a defect detected by an inspection unit is white line;

FIG. 19 is a diagram illustrating an example of input screen on an operation panel for receiving an operating input selecting a print-restart prediction criterion; and

FIG. 20 is a diagram illustrating an example of input screen on the operation panel for receiving an operating input selecting a print-restart prediction criterion.

### DETAILED DESCRIPTION OF THE PREFERRED EMBODIMENTS

An inspection apparatus, an image forming apparatus, an inspection method and a computer-readable storage medium according to embodiments of the present invention are described in detail below with reference to the accompanying drawings.

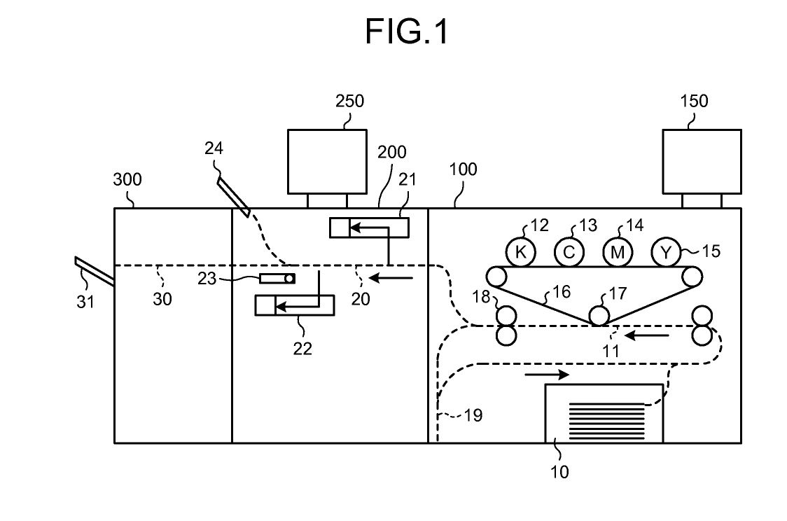

FIG. 1 is a schematic diagram illustrating an example configuration of an image forming system including an inspection apparatus according to an embodiment of the present invention. Referring to FIG. 1, the image forming system includes a printer apparatus 100 configured to perform printing to produce a printed product, an inspection apparatus 200 configured to inspect the printed product printed (produced) by the printer apparatus 100, and a paper discharge stacker 300 configured to store and hold normal printed products in which no defect is detected by the inspection apparatus 200. Meanwhile, the image forming system may be configured to include, in place of the paper discharge stacker 300, a finishing apparatus which performs finishing such as punching and/or stapling on normal printed products in which no defect is detected.

The printer apparatus 100 receives print information (print job) containing print image data (RIP (raster image processor) image) from, for example, an external apparatus such as a PC (personal computer) connected to the printer apparatus 100 over a network or a storage unit in the printer apparatus 100. The printer apparatus 100 performs the received print job to print a printed product.

More specifically, the printer apparatus 100 causes a sheet of printing paper for use in printing to be picked up from a paper feeding unit 10 and conveyed along a conveying path 11 in accordance with the print job. The printer apparatus 100 drives and causes a writing unit (not shown) to form electrostatic latent images for respective colors of K (black), C (cyan), M (magenta), and Y (yellow) on photoconductor drums 12, 13, 14, and 15, respectively, in accordance with the print image data contained in the print job. The electrostatic latent images formed on the photoconductor drums 12, 13, 14, and 15 are developed with coloring materials (toners) supplied from developing devices (not shown) into visible toner images.

The toner images on the photoconductive drums 12, 13, 14, and 15 are overlaid on one another on an intermediate transfer belt 16. A full-color toner image is thus obtained. As the intermediate transfer belt 16 revolves, the toner image on the intermediate transfer belt 16 is conveyed to reach a position of a transfer roller 17. At this position, the toner image is transferred onto printing paper which has been conveyed to the position along the conveying path 11. The toner image transferred onto the printing paper is fixed with heat and pressure applied to the toner image while passing between fixing rollers 18. In a case of simplex printing, the printing paper, on one side of which the toner image is fixed, is discharged to the inspection apparatus 200 as a printed product. In contrast, in a case of duplex printing, the printing paper, on one side of which the toner image is fixed, is turned upside down along a turn-upside-down path 19. Thereafter, a toner image is transferred and fixed onto the other side through a similar process. The printing paper onto both sides of which the toner images have been fixed is discharged to the inspection apparatus 200 as a printed product.

The printer apparatus 100 includes an operation panel 150. The printer apparatus 100 is capable of receiving an operating input provided by an operator or displaying various types of information using the operation panel 150.

The inspection apparatus 200 inspects a printed product printed by the printer apparatus 100 by comparing a scanned image obtained by optically scanning the printed product, which is being conveyed along a conveying path 20, using a scanner 21 or 22 with a master image generated from an RIP image, from which the printed product is printed. The inspection apparatus 200 controls a bifurcating claw 23 depending on a result of the inspection, so that a printed product in which a defect is detected is discharged onto a discard tray 24, while a printed product in which no defect is detected is discharged into the paper discharge stacker 300.

The inspection apparatus 200 includes an operation panel 250. The inspection apparatus 200 is capable of receiving an operating input provided by an operator or displaying various types of information using the operation panel 250. However, the inspection apparatus 200 does not necessarily include the operation panel 250 specific to the inspection apparatus 200. Alternatively, the operation panel 150 of the printer apparatus 100 may be configured to provide the function of receiving an operating input, which relates to the inspection apparatus 200, provided by an operator or displaying various types of information about the inspection apparatus 200 instead. Further alternatively, an external apparatus such as a PC connected to the inspection apparatus 200 over a network may be configured to provide the function of receiving an operating input, which relates to the inspection apparatus 200, provided by an operator or displaying various types of information about the inspection apparatus 200.

The paper discharge stacker 300 conveys a printed product in which no defect is detected by the inspection apparatus 200 along a conveying path 30 and discharges the printed product onto a paper discharge tray 31. Meanwhile, the bifurcating claw 23 and the discard tray 24 may be arranged in the paper discharge stacker 300 rather than in the inspection apparatus 200. When this configuration is employed, the paper discharge stacker 300 controls the bifurcating claw 23 depending on a result of inspection performed on a printed product by the inspection apparatus 200, so that a printed product in which a defect is detected is discharged onto the discard tray 24, while a printed product in which no defect is detected is discharged onto the paper discharge tray 31.

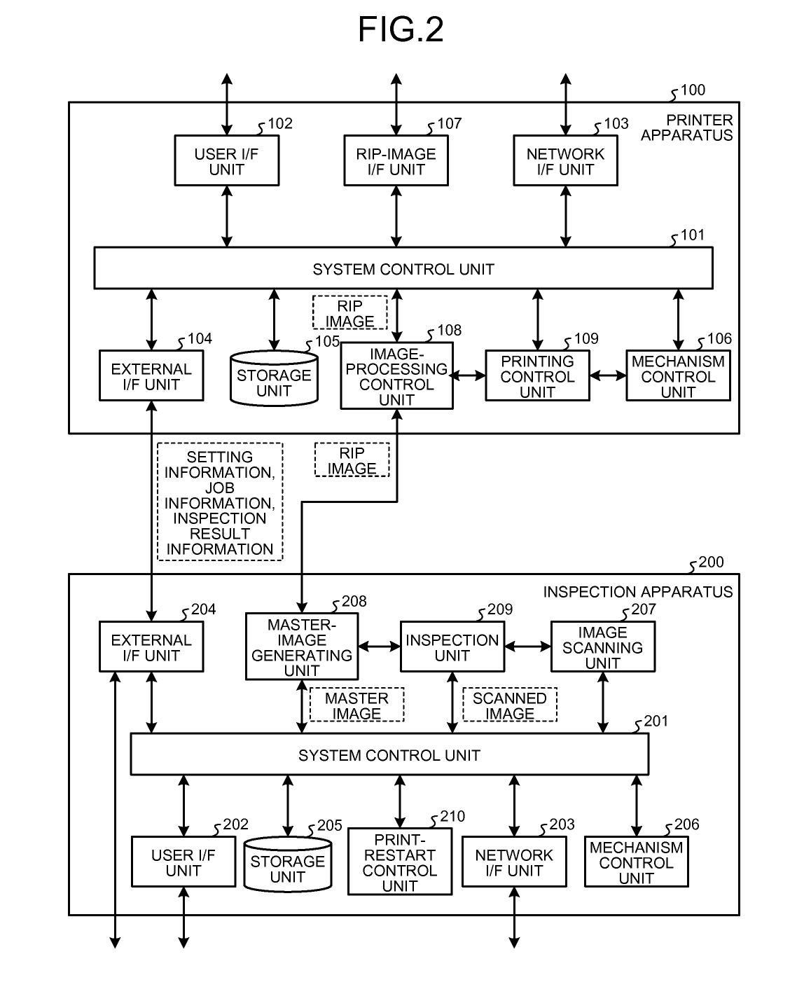

FIG. 2 is a block diagram illustrating an example configuration of the printer apparatus 100 and the inspection apparatus 200.

Referring to FIG. 2, the printer apparatus 100 includes a system control unit 101, a user I/F (interface) unit 102, a network I/F unit 103, an external I/F unit 104, a storage unit 105, a mechanism control unit 106, an RIP-image I/F unit 107, an image-processing control unit 108, and a printing control unit 109.

The system control unit 101 is a control unit which provides overall control of the printer apparatus 100 and includes an internal memory.

The user I/F unit 102 is an interface for connecting between the system control unit 101 and the operation panel 150.

The network I/F unit 103 is an interface for connecting the system control unit 101 to a network such as a LAN (local area network).

The external I/F unit 104 is an interface for connecting between the system control unit 101 and equipment outside the printer apparatus 100.

The storage unit 105 is a storage device, such as a hard disk drive, for storing various types of information. Examples of the information stored in the storage unit 105 include print jobs registered in advance.

The mechanism control unit 106 is a control unit which controls operations of various mechanism units to convey printing paper and perform a transfer process in accordance with a command fed from the system control unit 101.

The RIP-image I/F unit 107 is an interface for transferring an RIP image to and from an image generation controller (e.g., a DFE (digital front end)) which is an RIP image generator outside the printer apparatus 100. An RIP image is image data obtained by ripping (rasterizing) image data described in a predetermined description language.

The image-processing control unit 108 converts the RIP image into a print signal handled by the printing control unit 109.

The printing control unit 109 is a control unit which controls operations of the writing unit and the like based on the print signal, into which the RIP image is converted, in accordance with a command fed from the system control unit 101, thereby controlling image formation on printing paper.

Referring to FIG. 2, the inspection apparatus 200 includes a system control unit 201, a user I/F unit 202, a network I/F unit 203, an external I/F unit 204, a storage unit 205, a mechanism control unit 206, an image scanning unit 207, a master-image generating unit 208, an inspection unit 209, and a print-restart control unit 210.

The system control unit 201 is a control unit which provides overall control of the inspection apparatus 200.

The user I/F unit 202 is an interface for connecting between the system control unit 201 and the operation panel 250.

The network I/F unit 203 is an interface for connecting the system control unit 201 to a network such as a LAN.

The external I/F unit 204 is an interface for connecting between the system control unit 201 and equipment outside the inspection apparatus 200.

The storage unit 205 is a storage device, such as a hard disk drive, for storing various types of information. The storage unit 205 is not limited to a hard disk drive. A storage device of other type, such as a non-volatile memory, may alternatively be used as the storage unit 205. Further alternatively, an external memory connected to the inspection apparatus 200 via USB (universal serial bus) connection may be used as the storage unit 205.

The mechanism control unit 206 is a control unit which controls operations of mechanism units, the bifurcating claw 23, and the like to convey a printed product in accordance with a command fed from the system control unit 201.

The image scanning unit 207 is configured to optically scan a printed product and outputs a scanned image. The image scanning unit 207 corresponds to the scanners 21 and 22 illustrated in FIG. 1.

The master-image generating unit 208 generates a master image by receiving a to-be-printed RIP image from the image-processing control unit 108 of the printer apparatus 100 and performs, on the RIP image, resolution conversion, color conversion, and the like which depends on a scanning condition used by the image scanning unit 207. Note that the master-image generating unit 208 receives the to-be-printed RIP image and generates the master image before the printer apparatus 100 produces the printed product by printing the RIP image. Accordingly, the master-image generating unit 208 can generate a master image corresponding to a printed product which is not yet actually printed by the printer apparatus 100 in advance.

The inspection unit 209 inspects the printed product printed by the printer apparatus 100 for a defect by comparing the scanned image output from the image scanning unit 207 with the master image generated by the master-image generating unit 208. For instance, the inspection unit 209 calculates a difference of pixel value between a pixel of the scanned image and a pixel of the master image corresponding to the pixel of the scanned image, and counts the pixels each having the difference of pixel value larger than a predetermined value. When a ratio of the number of the counted pixels to a total number of pixels exceeds a reference value, the inspection unit 209 determines that the printed product has a defect.

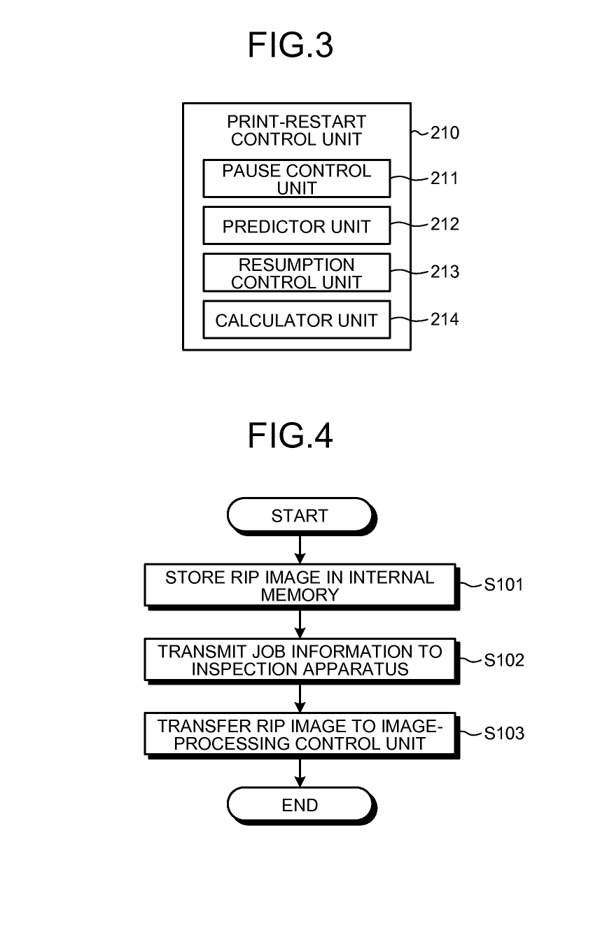

The print-restart control unit 210 is a control unit which controls the printer apparatus 100 to restart printing when a defect is detected in the printed product by the inspection unit 209. The print-restart control unit 210 includes functional elements including a pause control unit 211, a predictor unit 212, a resumption control unit 213, and a calculator unit 214 as illustrated in FIG. 3, for example.

When the inspection unit 209 detects a defect in any page of a printed product containing multiple pages while the printer apparatus 100 is continuously printing the printed product, the pause control unit 211 causes the system control unit 201 to issue a print pause command to the printer apparatus 100, thereby causing the printer apparatus 100 to pause printing. In the embodiment, the pause control unit 211 is implemented as a function of the print-restart control unit 210. Alternatively, the pause control unit 211 may be implemented as a function of the system control unit 201.

When printing by the printer apparatus 100 is paused by the pause control unit 211, the predictor unit 212 predicts whether or not a defect will be detected again in a printed product obtained during restarting printing. This prediction is made by using master images of pages which are not printed by the printer apparatus 100 yet (hereinafter, “not-yet-printed master images”) generated by the master-image generating unit 208, a master image of the page where the defect is detected by the inspection unit 209, and a predetermined defect prediction criterion. Specific examples of the defect prediction criterion and how the predictor unit 212 performs processing using the defect prediction criterion will be described in detail later.

If the predictor unit 212 predicts that a defect will not be detected again in restarting printing, the resumption control unit 213 permits the printer apparatus 100 to restart printing of the page where the defect is detected by the inspection unit 209 and pages that follow the defect-detected page by, for example, notifying the printer apparatus 100 that restarting printing is permitted. On the other hand, if the predictor unit 212 predicts that a defect will be detected again in restarting printing, the resumption control unit 213 prohibits the printer apparatus 100 from restarting printing by, for example, notifying the printer apparatus 100 that restarting printing is prohibited.

In a case where the predictor unit 212 uses a criterion for a toner (coloring-material) consumption ratio of the printed product as the defect prediction criterion described above, the calculator unit 214 calculates toner consumption ratios of the printed product corresponding to the master images based on the master images generated by the master-image generating unit 208. The toner consumption ratios are ratios of toner amounts of the respective colors (CMYK) to be consumed to toner amounts to be consumed for the entire image. For instance, the calculator unit 214 can calculate an average pixel value of a master image for each color plane of C, M, Y, and K and divides the average pixel value by 255, thereby obtaining a toner consumption ratio for each of C, M, Y, and K. Alternatively, the calculator unit 214 may be configured to obtain a toner consumption ratio for each of C, M, Y, and K on a per-page basis from the printer apparatus 100.

Operation of the image forming system according to the embodiment configured as described above is described below. First, operation of the printer apparatus 100 during normal printing is described below. FIG. 4 is a flowchart illustrating an example of processing procedure for the system control unit 101 of the printer apparatus 100 during normal printing.

The system control unit 101 starts processing illustrated in the flowchart of FIG. 4 in accordance with a print-job execution command. The system control unit 101 stores either an RIP image received from the RIP-image I/F unit 107 or an RIP image generated in accordance with a content of the print job stored in the storage unit 105, in the internal memory (Step S101).

Subsequently, the system control unit 101 directs the mechanism control unit 106 and the printing control unit 109 to execute the print job to perform a printing operation, and transmits information about the job to the inspection apparatus 200 via the external I/F unit 104 (Step S102). Meanwhile, the job information transmitted from the system control unit 101 of the printer apparatus 100 to the inspection apparatus 200 contains the following information:
page identification information,
information about printing paper to be used on a per-page basis,
information as to which color plane(s) of CMYK is used,
information about simplex/duplex printing,
information as to which one of front side/back side of the printing paper is printed, and
information as to what finishing is performed by a finisher when the image forming system includes the finisher.

The system control unit 101 transfers the RIP image stored in the internal memory to the image-processing control unit 108 in response to a request from the image-processing control unit 108 (Step S103).

Upon receiving the RIP image from the system control unit 101, the image-processing control unit 108 converts the RIP image into a print signal in accordance with a request from the printing control unit 109. The image-processing control unit 108 transfers the print signal to the printing control unit 109 and transmits the RIP image to the inspection apparatus 200. When the print signal transferred from the image-processing control unit 108 is received by the printing control unit 109, printing of a printed product corresponding to the RIP image is started. With respect to timing, the image-processing control unit 108 transmits the RIP image to the inspection apparatus 200 earlier than when the printed product is actually printed and conveyed to the inspection apparatus 200.

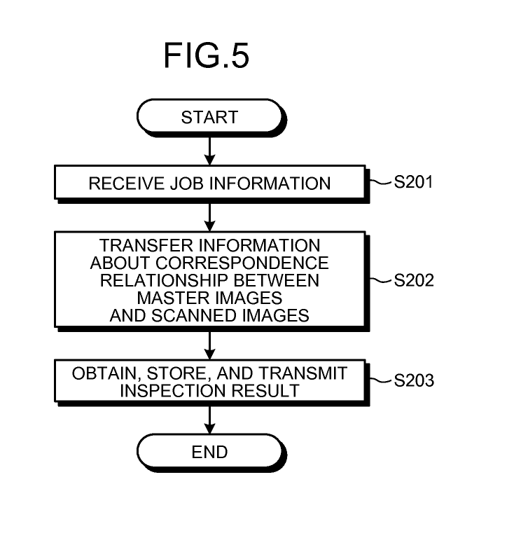

Operation of the inspection apparatus 200 during normal printing is described below. FIG. 5 is a flowchart illustrating an example of processing procedure for the system control unit 201 of the inspection apparatus 200 during normal printing.

The system control unit 201 of the inspection apparatus 200 receives the job information transmitted from the printer apparatus 100 via the external I/F unit 204 first (Step S201), and transmits necessary information, which depends on the job information, to the paper discharge stacker 300 at a subsequent stage.

Subsequently, the system control unit 201 generates correspondence information representing correspondence relationship between master images, which are generated from RIP images by the master-image generating unit 208, based on the job information received at Step S201 and scanned images obtained by the image scanning unit 207 (the scanner 21, 22) by scanning the printed product and transfers the generated correspondence information to the inspection unit 209 (Step S202). The inspection unit 209 inspects the printed product by obtaining the page-by-page correspondence relationship between the master images and the scanned images by means of this correspondence information.

Subsequently, the system control unit 201 obtains a inspection result performed on the printed product from the inspection unit 209, stores and saves the inspection result in the storage unit 205, and transmits the inspection result to a designated destination (Step S203). More specifically, for example, the system control unit 201 may transmit the inspection result output from the inspection unit 209 to the printer apparatus 100 and the paper discharge stacker 300 via the external I/F unit 204, transmit the same to the operation panel 250 via the user I/F unit 202, or transmit the same to a PC connected to the network via the network I/F unit 203.

The inspection apparatus 200 can generate a master image immediately when receiving an RIP image from the printer apparatus 100. This is because the master image is generated from the RIP image. In contrast, a scanned image is generated as follows. A printed product is actually printed by the printer apparatus 100 through a predetermined printing process and discharged into the inspection apparatus 200. Thereafter, the image scanning unit 207 (the scanner 21, 22) scans the printed product conveyed inside the inspection apparatus 200, thereby generating the scanned image. Accordingly, in a situation where a printed product containing multiple pages is continuously printed, before a scanned image of a certain page is obtained, master images of several pages that follow the certain page are generated. Meanwhile, how many master images that follow a certain page are generated before a scanned image of the certain page is obtained varies depending on performance, such as a printing speed, of the printer apparatus 100, processing capability of the inspection apparatus 200, and the like.

Operation of the inspection apparatus 200 in a situation where a defect is detected in one page of a printed product containing multiple pages while the printed product is continuously printed is described below by way of a specific example. It is assumed in this example that a defect is detected in the 3rd page of a printed product containing multiple pages while the printed product is continuously printed. It is also assumed that at a point in time when the inspection unit 209 detects the defect in the 3rd page, the printer apparatus 100 has been printed up to the 8th page, and the to 8th pages of the printed product have been conveyed into the inspection apparatus 200. It is also assumed that at the point in time when the inspection unit 209 detects the defect in the 3rd page, the master-image generating unit 208 has generated master images of up to the 12th pages. In other words, in this example, master images from the 9th to 12th pages are not-yet-printed master images.

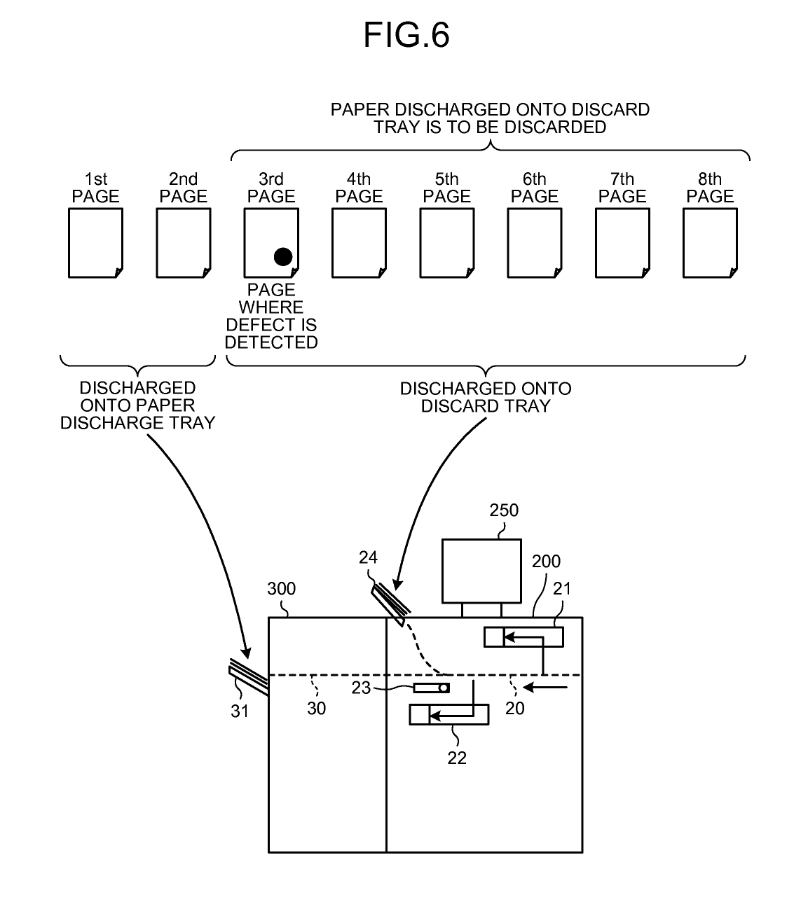

FIG. 6 is a schematic diagram illustrating a specific example of operation of the inspection apparatus 200 in the situation described above. The inspection apparatus 200 discharges the and 2nd pages of the printed product where no defect is detected into the paper discharge stacker 300, and these pages are discharged onto the paper discharge tray 31. Upon detecting the defect in the 3rd page of the printed product, the inspection apparatus 200 causes the printer apparatus 100 to pause printing and discharges the 3rd page, and the 4th to 8th pages of the printed product which have already been printed by the printer apparatus 100 and conveyed inside the inspection apparatus 200 at the point in time onto the discard tray 24. The 3rd to 8th pages of the printed product discharged onto the discard tray 24 are discarded. By discarding the 3rd to 8th pages in this manner, pages of the printed product discharged onto the paper discharge tray 31 can be arranged in a correct order when the printer apparatus 100 restarts printing from the 3rd page where the defect is detected.

In this example, it is assumed that, at the point in time when printing is paused upon detection of the defect in the 3rd page, the printer apparatus 100 has printed five pages from the 4th to 8th pages. However, the number of pages that follow a page where a defect is detected are printed by the printer apparatus 100 at a point in time when the defect is detected varies depending on performance, such as a printing speed of the printer apparatus 100, processing capability of the inspection apparatus 200, and the like.

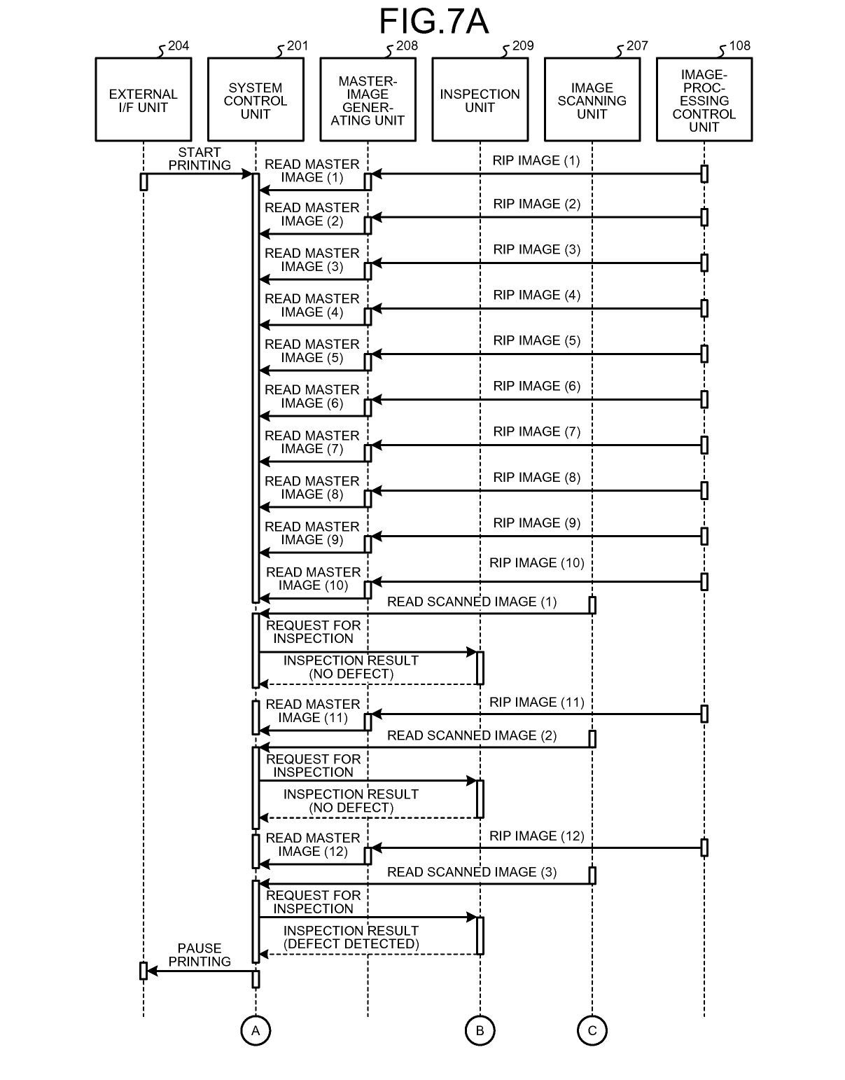

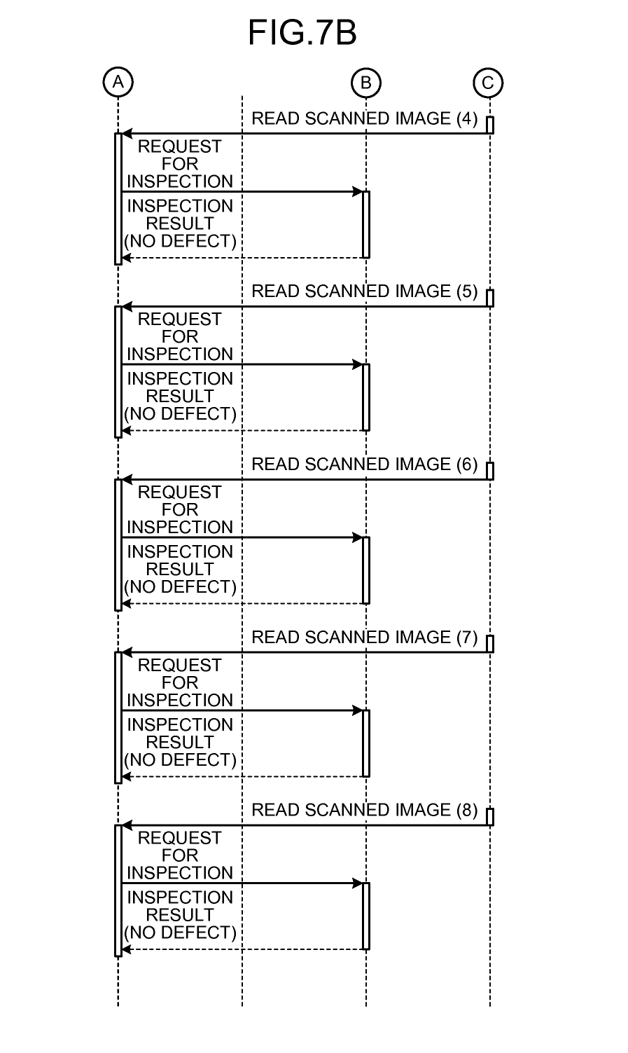

FIGS. 7A and 7B are sequence diagrams illustrating a specific example of operation of the inspection apparatus 200 in the above-described situation. FIG. 7B is a diagram continued from FIG. 7A. Each number inside parentheses in FIGS. 7A and 7B represents an ordinal number of a corresponding page. It should be noted that the sequence diagrams illustrated in FIGS. 7A and 7B illustrate only an example, and timing as to when the system control unit 201 should read master images, timing as to when the system control unit 201 should read scanned images, and the like vary depending on a specific configuration of the inspection apparatus 200.

Referring to FIGS. 7A and 7B, when scanning of the printed product by the image scanning unit 207 is completed, the system control unit 201 of the inspection apparatus 200 reads the scanned image, passes the scanned image and a master image, which corresponds to the scanned image and which has been read in advance, to the inspection unit 209, requests the inspection unit 209 to perform inspection, and receives an inspection result from the inspection unit 209. When the received inspection result indicates that the printed product has a defect, the system control unit 201 causes the printer apparatus 100 to pause printing by transmitting a print pause command to the printer apparatus 100 via the external I/F unit 204. In the example illustrated in FIGS. 7A and 7B, printing is paused when the defect is detected in the 3rd page. At this point in time, the system control unit 201 has read master images of up to the 12th pages. Furthermore, printing of up to the 8th page is completed at the point in time when printing is paused. Accordingly, even after printing is paused, scanning of the printed product, reading of scanned images, and inspection of up to the 8th page are continued. Meanwhile, the pages that follow the defect-detected page of the printed product are discharged onto the discard tray 24 and discarded irrespective of inspection results of the pages. Therefore, the system control unit 201 may be configured not to inspect the pages that follow the defect-detected page of the printed product.

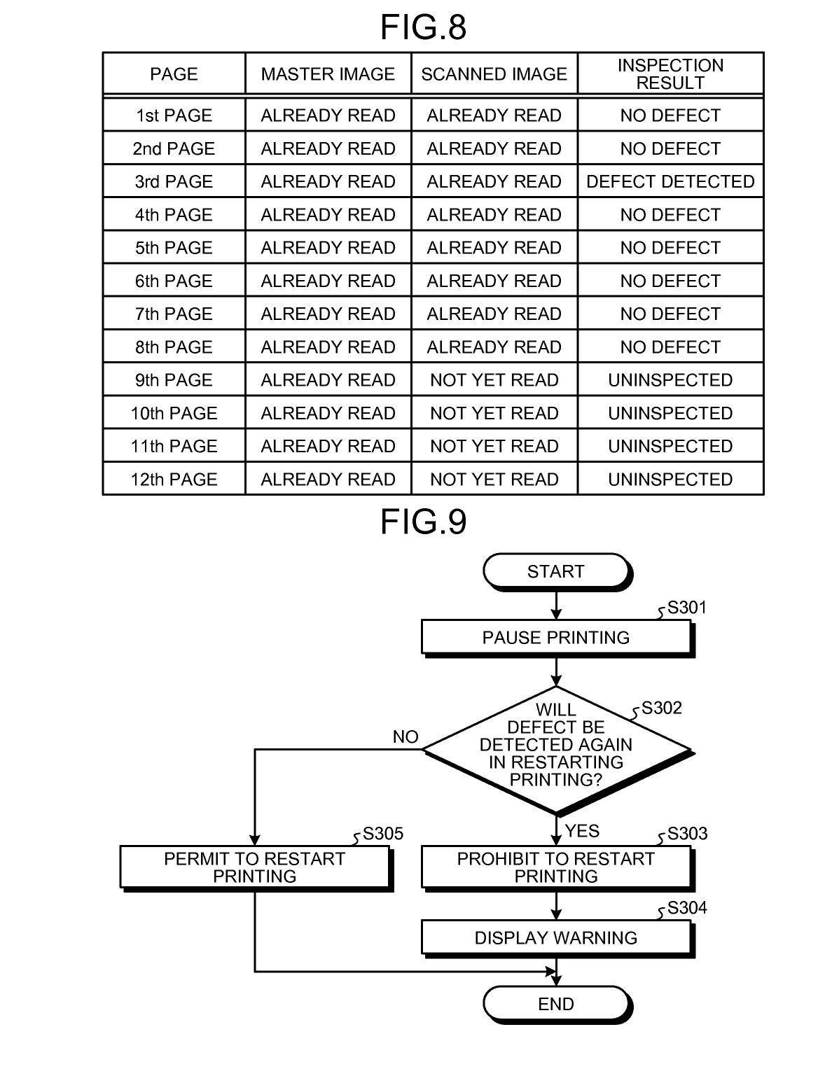

FIG. 8 is a table of master images, scanned images, and inspection results in the above-described situation put into categories on a per-page-basis. Referring to the table of FIG. 8, reading of the master images of the 9th to 12th pages is completed. However, because the printed product is not conveyed into the inspection apparatus 200 due to pause of printing, scanned images of the 9th to 12th pages are not obtained yet, and therefore inspection thereof is not performed. In other words, the master images of the 9th to 12th pages are not-yet-printed master images. The 1st and 2nd pages of the printed product are discharged onto the paper discharge tray 31 of the paper discharge stacker 300 because the inspection result thereof indicates that there is no defect. The 3rd to 8th pages of the printed product are discharged onto the discard tray 24 and discarded because the inspection result thereof indicates that the 3rd page of the printed product has the defect.

When printing is restarted, the printer apparatus 100 restarts printing from the 3rd page where the defect is detected. It should be noted that, in the image forming system according to the embodiment, the print-restart control unit 210 of the inspection apparatus 200 predicts whether or not a defect will be detected again in restarting printing by using a master image of a defect-detected page (in this example, the master image of the 3rd page), not-yet-printed master images (in this example, the master images of the 9th to 12th pages), and a predetermined defect prediction criterion. The printer apparatus 100 is permitted to restart printing only when it is predicted that a defect will not be detected again in restarting printing. The printer apparatus 100 is prohibited from restarting printing if it is predicted that a defect will be detected again in restarting printing. Simultaneously therewith, a warning that a defect will be highly possibly detected again in restarting printing may preferably be displayed on the operation panel 250.

FIG. 9 is a flowchart illustrating an example of processing procedure for the print-restart control unit 210 of the inspection apparatus 200. The print-restart control unit 210 starts processing illustrated in the flowchart of FIG. 9 when a defect is detected in one page of a printed product containing multiple pages while the printed product is continuously printed.

When a defect is detected in one page by the inspection unit 209, the pause control unit 211 causes the printer apparatus 100 to pause printing by, for example, causing the system control unit 201 to issue a print pause command (Step S301).

Subsequently, the predictor unit 212 predicts whether or not a defect will be detected again in restarting printing using a master image of the defect-detected page, not-yet-printed master images, and a predetermined defect prediction criterion (Step S302).

If the predictor unit 212 predicts that a defect will be detected again in restarting printing (Yes at Step S302), the resumption control unit 213 prohibits the printer apparatus 100 from restarting printing by, for example, notifying the printer apparatus 100 that restarting printing is prohibited (Step S303). Concurrent therewith, the operation panel 304 displays a warning that a defect will be highly possibly detected again in restarting printing (Step S304).

On the other hand, if the predictor unit 212 predicts that a defect will not be detected again in restarting printing (No at Step S302), the resumption control unit 213 permits the printer apparatus 100 to restart printing by, for example, notifying the printer apparatus 100 that restarting printing is permitted (Step S305). Upon being permitted, the printer apparatus 100 restarts printing from the defect-detected page (in the example described above, the 3rd page).

Specific examples of the defect prediction criterion for use in predicting whether or not a defect will be detected again in restarting printing are described below. As the defect prediction criterion, for example, a criterion that at least one of not-yet-printed master images should have a similarity of a predetermined first threshold or higher can be used. More specifically, prediction using this criterion is made such that, if the not-yet-printed master images include a master image identical or similar to a master image of a defect-detected image, a defect will be detected again in restarting printing. Hereinafter, this criterion is referred to as “image similarity criterion”. Similarity between master images for this criterion can be calculated by utilizing a known index indicating an image similarity. Examples of the index include an index calculated using average pixel values and that calculated using a histogram. The first threshold can be any appropriate value determined in advance.

As the defect prediction criterion, for another example, a criterion that a difference between a toner (coloring-material) consumption ratio calculated from at least one of the not-yet-printed master images and a toner (coloring-material) consumption ratio calculated from the master page of the defect-detected page should have a similarity of a predetermined second threshold or lower can be used. More specifically, prediction using this criterion is made such that, if the not-yet-printed master images include a master image, whose toner consumption ratio is identical or similar to that of the master image of the defect-detected image, a defect will be detected again in restarting printing. Hereinafter, this criterion is referred to as “toner-consumption-ratio similarity criterion”. The calculator unit 214 described above calculates toner consumption ratios for respective master-images in this case. The second threshold can be any appropriate value determined in advance.

Prediction by the image similarity criterion or the toner-consumption-ratio similarity criterion may be made by additionally using a master image of a page which belongs to the same job and where a defect has been detected previously as a master image (master image of a defect-detected page) serving as a comparison reference with which not-yet-printed master images are compared. More specifically, when a defect is detected in one page and printing is paused, a master image of the defect-detected page is held by storing the master image in the storage unit 205 or the like. In such a situation that a defect is detected again in restarting printing that is restarted because a prediction is made that a defect will not be detected again, the master image of the page where the defect has been detected previously is read out from the storage unit 205. Prediction as to whether a defect is detected again in restarting printing is then made using a master image of the page where the defect is newly detected and the master image of the page where the defect has been detected previously as the comparison reference of not-yet-printed master images.

As the defect prediction criterion, for example, a criterion that at least one of not-yet-printed master images should have image features, which have been determined in advance according to a type of a defect detected by the inspection unit 209, can be used. More specifically, prediction using this criterion is made as follows, for example. When the defect detected by the inspection unit 209 is a defect of color unevenness, if at least one of the not-yet-printed master images indicates using toner of the same color as that of the color unevenness, prediction is made that a defect will be detected again in restarting printing. When the defect detected by the inspection unit 209 is a defect of white line, if at least one of the not-yet-printed master images indicates using any one of the C, M, Y, and K toners at a position corresponding to the position of the detected white line, prediction is made that a defect will be detected again in restarting printing. When the defect detected by the inspection unit 209 is a defect of dark line, if all of the not-yet-printed master images indicate using the K toner at a position corresponding to the position of the detected dark line, prediction is made that a defect will not be detected again in restarting printing. Hereinafter, this criterion is referred to as “image feature criterion”.

The predictor unit 212 may use the image similarity criterion, the toner-consumption-ratio similarity criterion, and the image feature criterion described above singularly as the defect prediction criterion or, alternatively, may use a combination of two or more of these criteria as the defect prediction criterion. Another criteria may be combined with the image similarity criterion, the toner-consumption-ratio similarity criterion, or the image feature criterion described above and used as the defect prediction criterion. Another criterion include that, for example, if a defect is detected also in at least one of pages (in the above-described example, the 4th to 8th pages), which follow a defect-detected page and have already been printed at a point in time when printing is paused, of a printed product, prediction is made that a defect will be detected again in restarting printing.

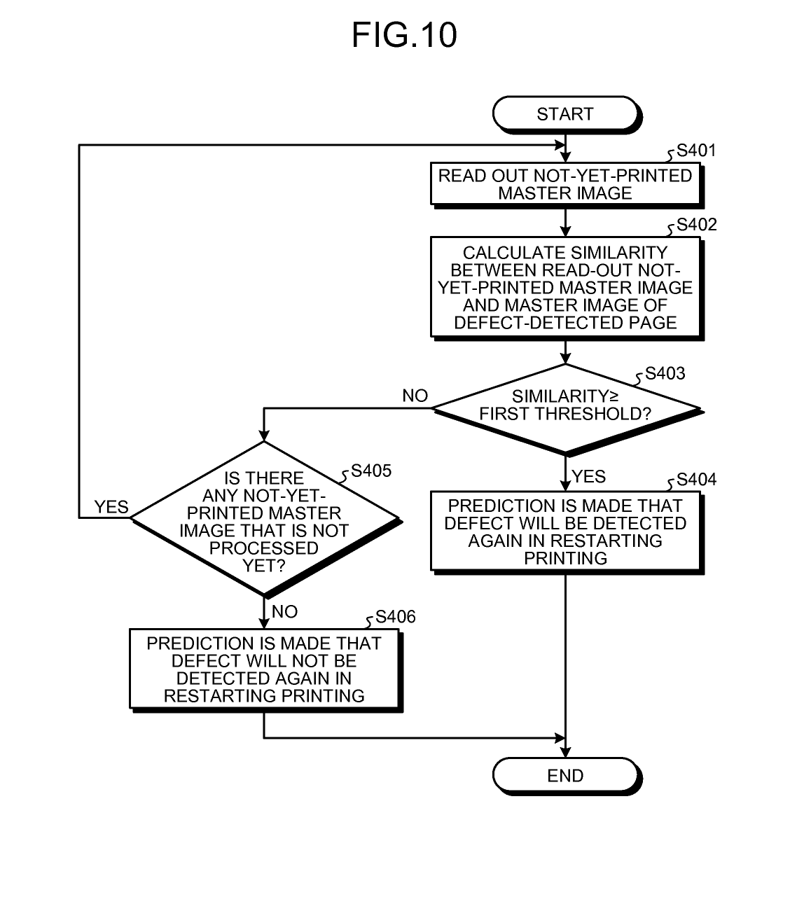

FIG. 10 is a flowchart illustrating an example of processing procedure for the predictor unit 212 which uses the image similarity criterion as the defect prediction criterion.

The predictor unit 212 reads out not-yet-printed master images one by one in order from the storage unit 205 or the like (Step S401). There can be a case where there is no not-yet-printed master image because a defect is detected in a page near an end of a job or in the last page. In such a case, processing ends without any further operation.

The predictor unit 212 calculates a similarity between the not-yet-printed master image read out at Step S401 and a master image of a page where a defect is detected (Step S402), and determines whether or not the calculated similarity is equal to or higher than the predetermined first threshold (Step S403). If the similarity calculated at Step S402 is equal to or higher than the first threshold (Yes at Step S403), the predictor unit 212 predicts that a defect will be highly possibly detected again in restarting printing or, in short, a defect will be detected again (Step S404), then processing ends.

If the similarity calculated at Step S402 is lower than the first threshold (No at Step S403), the predictor unit 212 determines whether or not there is any not-yet-printed master image that is not processed yet (Step S405). If there is any not-yet-printed master image that is not processed yet (Yes at Step S405), processing returns to Step S401 to repeat Step S401 and the steps that follow Step S401. If there is no not-yet-printed master image that is not processed yet (No at Step S405), the predictor unit 212 predicts that a defect will be less likely detected again in restarting printing or, in short, a defect will not be detected again (Step S406), then processing ends.

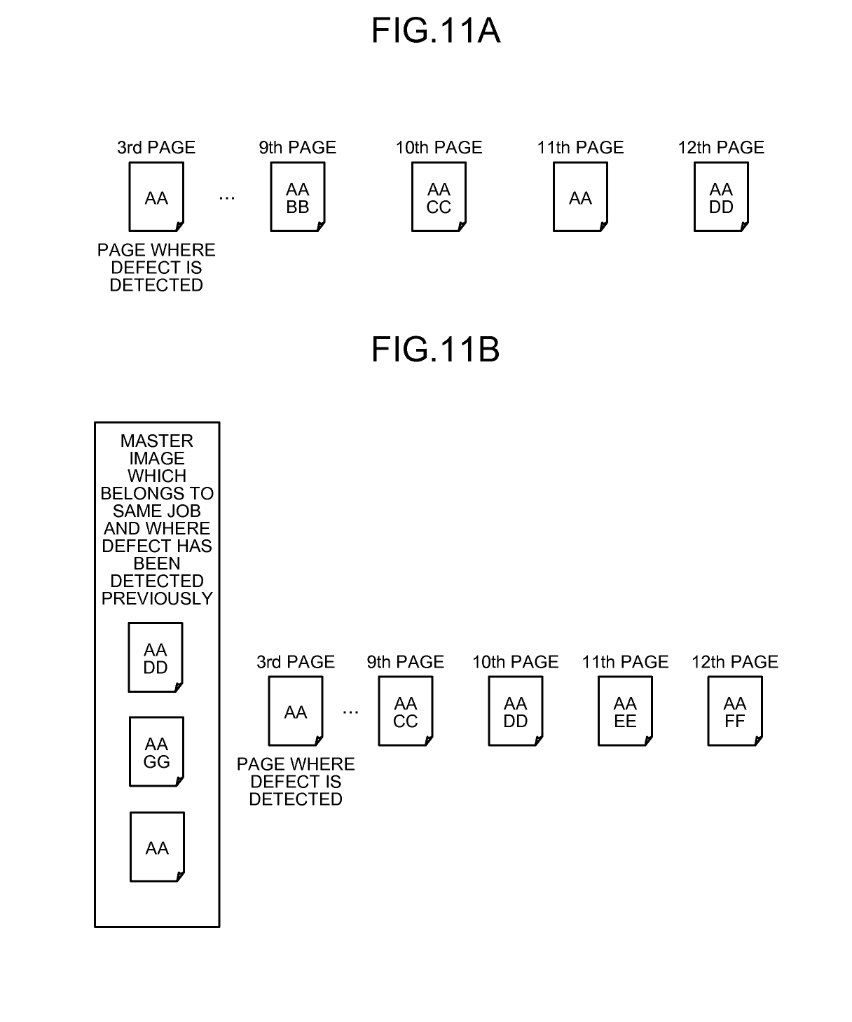

FIGS. 11A and 11B are schematic diagrams illustrating specific example situations of the above-described example in each of which it is predicted, by the image similarity criterion, that a defect will be detected again in restarting printing. In the example illustrated in FIG. 11A where the 9th to 12th pages are not-yet-printed master images, a similarity between a not-yet-printed master image of the 11th page and a master image of the page where a defect is detected is equal to or higher than the first threshold. Accordingly, the predictor unit 212 predicts that a defect will be detected again in restarting printing. In the example illustrated in FIG. 11B where the 9th to 12th pages are not-yet-printed master images, a similarity between a not-yet-printed master image of the 10th page and a master image which belongs to the same job and where a defect has been detected previously is equal to or higher than the first threshold. Accordingly, the predictor unit 212 predicts that a defect will be detected again in restarting printing.

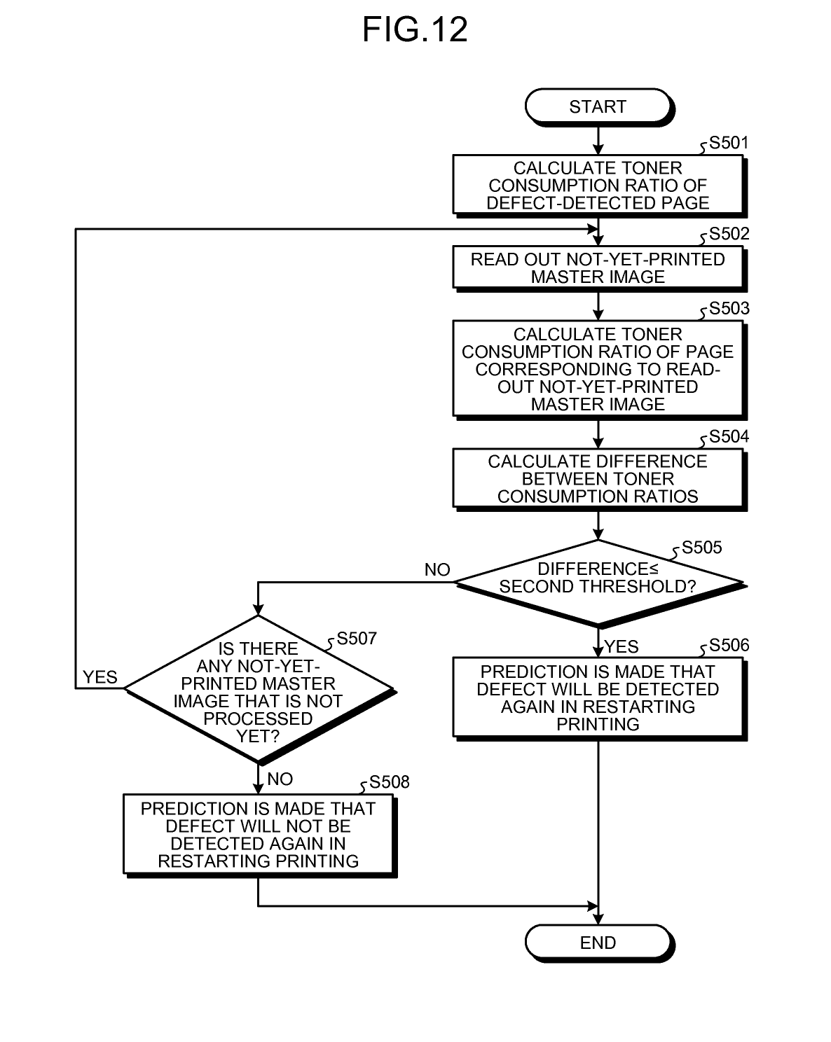

FIG. 12 is a flowchart illustrating an example of processing procedure for the predictor unit 212 which uses the toner-consumption-ratio similarity criterion as the defect prediction criterion.

The predictor unit 212 passes a master image of a defect-detected page to the calculator unit 214 and causes the calculator unit 214 to calculate a toner consumption ratio of the defect-detected page (Step S501).

Subsequently, the predictor unit 212 reads out not-yet-printed master images one by one in order from the storage unit 205 or the like (Step S502). There can be a case where there is no not-yet-printed master image because a defect is detected in a page near an end of a job or in the last page. In such a case, processing ends without any further operation.

Subsequently, the predictor unit 212 passes the not-yet-printed master image read out at Step S502 to the calculator unit 214 and causes the calculator unit 214 to calculate a toner consumption ratio of a page corresponding to the not-yet-printed master image (Step S503).

Subsequently, the predictor unit 212 calculates a difference between the toner consumption ratio calculated at Step S501 and the toner consumption ratio calculated at Step S503 (Step S504) and determines whether or not the calculated difference is equal to or lower than the predetermined second threshold (Step S505). If the difference calculated at Step S504 is equal to or lower than the second threshold (Yes at Step S505), the predictor unit 212 predicts that a defect will be highly possibly detected again in restarting printing or, in short, a defect will be detected again (Step S506), then processing ends.

On the other hand, if the difference calculated at Step S504 is higher than the second threshold (No at Step S505), the predictor unit 212 determines whether or not there is any not-yet-printed master image that is not processed yet (Step S507). If there is any not-yet-printed master image that is not processed yet (Yes at Step S507), processing returns to Step S502 to repeat Step S502 and the steps that follow Step S502. If there is no not-yet-printed master image that is not processed yet (No at Step S507), the predictor unit 212 predicts that a defect will be less likely detected again in restarting printing or, in short, a defect will not be detected again (Step S508), then processing ends.

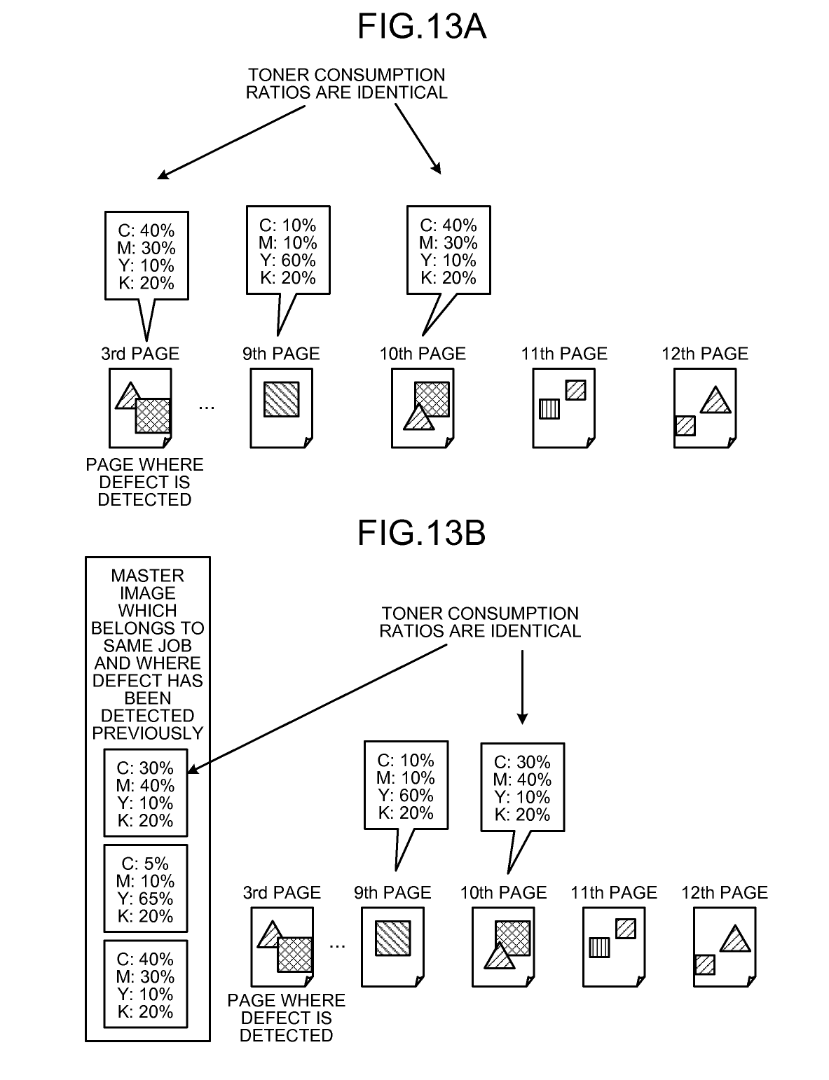

FIGS. 13A and 13B are schematic diagrams illustrating specific example situation of the above-described example in each of which it is predicted, by the toner-consumption-ratio similarity criterion, that a defect will be detected again in restarting printing. In the example illustrated in FIG. 13A where the 9th to 12th pages are not-yet-printed master images, a toner consumption ratio calculated from a not-yet-printed master image of the 10th page is equal to a toner consumption ratio of a master image of the 3rd page where a defect is detected. Accordingly, the predictor unit 212 predicts that a defect will be detected again in restarting printing. In the example illustrated in FIG. 13B where the 9th to 12th pages are not-yet-printed master images, the toner consumption ratio calculated from the not-yet-printed master image of the 10th page is equal to that of a master image which belongs to the same job and where a defect has been detected previously. Accordingly, the predictor unit 212 predicts that a defect will be detected again in restarting printing.

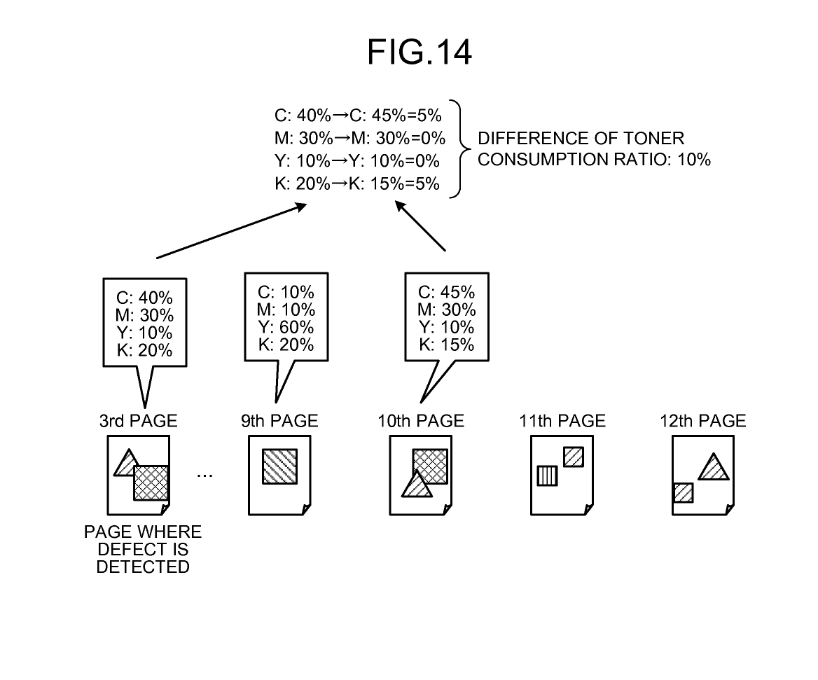

FIG. 14 is a schematic diagram illustrating another specific example situation of the above-described example where it is predicted, by the toner-consumption-ratio similarity criterion, that a defect will be detected again in restarting printing. In the example illustrated in FIG. 14 where the 9th to 12th pages are not-yet-printed master images, a difference between a toner consumption ratio calculated from a not-yet-printed master image of the 10th page and a toner consumption ratio of a master image of the 3rd page where a defect is detected is 10%, which is equal to or lower than the second threshold. Accordingly, the predictor unit 212 predicts that a defect will be detected again in restarting printing.

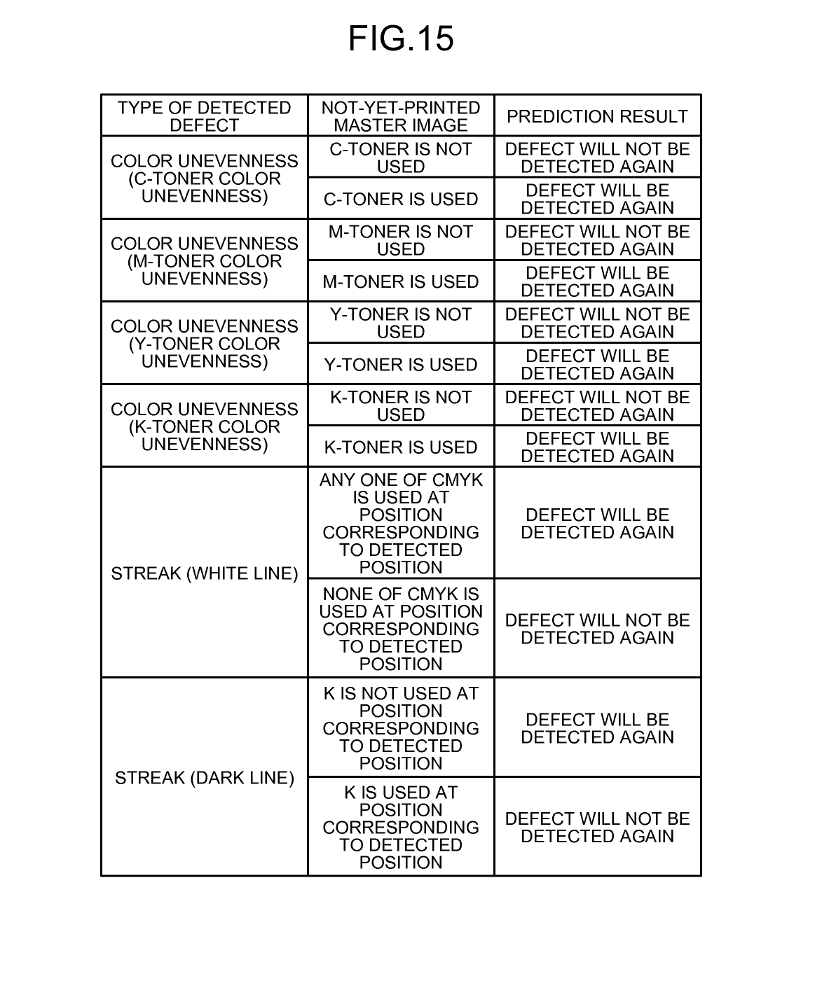

FIG. 15 is a table describing an example of the image feature criterion described above and illustrating correspondence relationship between image feature related to a defect type, and prediction results made by the predictor unit 212. When prediction is made by the image feature criterion, the predictor unit 212 makes prediction as illustrated in FIG. 15, for example. More specifically, when the type of the defect detected by the inspection unit 209 is C (cyan) color unevenness, the predictor unit 212 predicts that a defect will not be detected again in restarting printing if none of the not-yet-printed master images indicates using the C toner, whereas predicts that a defect will be detected again in restarting printing if at least one of the not-yet-printed master images indicates using the C toner. When the type of the defect detected by the inspection unit 209 is M (magenta) color unevenness, the predictor unit 212 predicts that a defect will not be detected again in restarting printing if none of the not-yet-printed master images indicates using the M toner, whereas predicts that a defect will be detected again in restarting printing if at least one of the not-yet-printed master images indicates using the M toner. When the type of the defect detected by the inspection unit 209 is Y (yellow) color unevenness, the predictor unit 212 predicts that a defect will not be detected again in restarting printing if none of the not-yet-printed master images indicates using the Y toner, whereas predicts that a defect will be detected again in restarting printing if at least one of the not-yet-printed master images indicates using the Y toner. When the type of the defect detected by the inspection unit 209 is K (black) color unevenness, the predictor unit 212 predicts that a defect will not be detected again in restarting printing if none of the not-yet-printed master images indicates using the K toner, whereas predicts that a defect will be detected again in restarting printing if at least one of the not-yet-printed master images indicates using the K toner.

When the type of the defect detected by the inspection unit 209 is white line, the predictor unit 212 predicts that a defect will be detected again in restarting printing if at least one of the not-yet-printed master images indicates using any one of the CMYK toners at a position corresponding to the position of the detected white line, whereas predicts that defect will not be detected again in restarting printing if none of the not-yet-printed master images indicates using the C, M, Y, or K toner at the position corresponding to the position of the detected white line. When the type of the defect detected by the inspection unit 209 is dark line, the predictor unit 212 predicts that a defect will be detected again in restarting printing if at least one of the not-yet-printed master images indicates not using the K toner at a position corresponding to the position of the detected dark line, whereas predicts that defect will not be detected again in restarting printing if all of the not-yet-printed master images indicate using the K toner at the position corresponding to the position of the detected dark line. The position of a not-yet-printed master image for use in determining whether or not toner is to be used or, more specifically, the position of the not-yet-printed master image corresponding to the detected white line or dark line, can be set in accordance with an operating input or the like provided by an operator by utilizing the operation panel 250, for example, as appropriate.

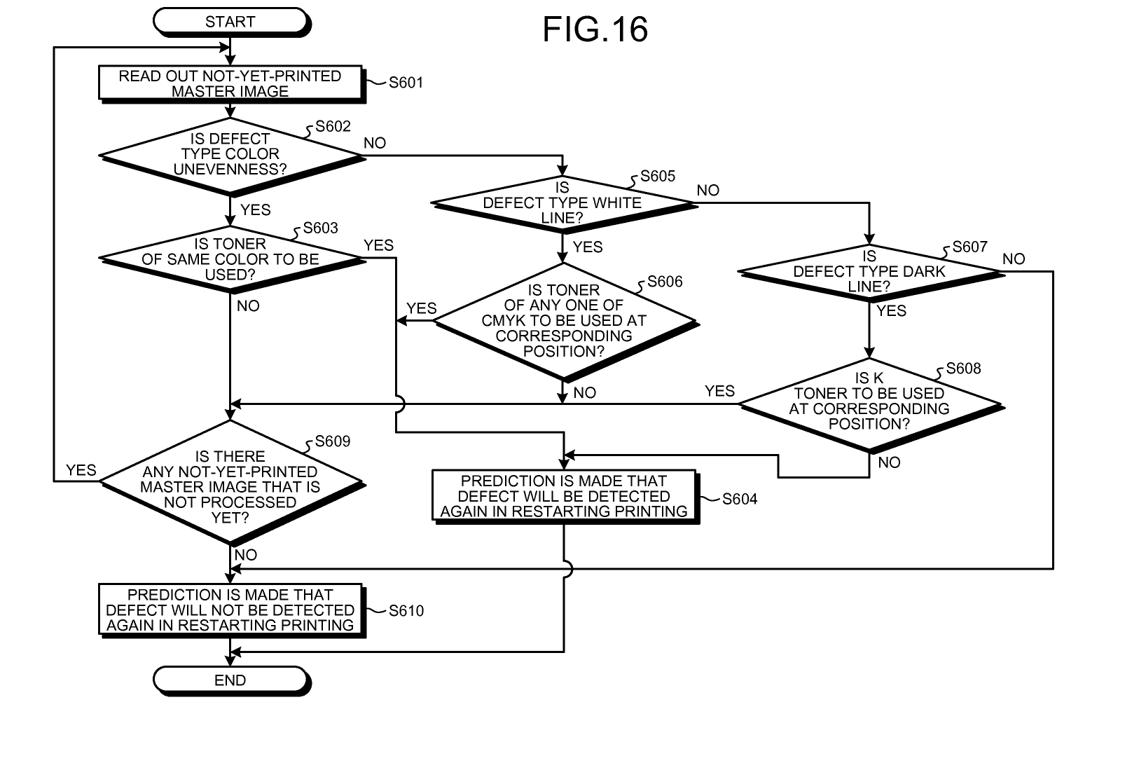

FIG. 16 is a flowchart illustrating an example of processing procedure for the predictor unit 212 which uses the image feature criterion as the defect prediction criterion.

The predictor unit 212 reads out not-yet-printed master images one by one in order from the storage unit 205 or the like (Step S601). There can be a case where there is no not-yet-printed master image because a defect is detected in a page near an end of a job or in the last page. In such a case, processing ends without any further operation.

Subsequently, the predictor unit 212 determines whether or not the type of the defect detected by the inspection unit 209 is color unevenness (Step S602). If the defect type is color unevenness(Yes at Step S602), the predictor unit 212 determines whether or not the not-yet-printed master image read out at Step S601 indicates using toner of the same color unevenness (Step S603). If the not-yet-printed master image indicates using the toner of the same color unevenness (Yes at Step S603), the predictor unit 212 predicts that a defect will be highly possibly detected again in restarting printing or, in short, a defect will be detected again (Step S604), then processing ends. On the other hand, if the not-yet-printed master image indicates not using the toner of the same color unevenness (No at Step S603), processing proceeds to Step S609.

If the defect type is determined not to be color unevenness (No at Step S602), the predictor unit 212 determines whether or not the type of the defect detected by the inspection unit 209 is white line (Step S605). If the defect type is white line (Yes at Step S605), the predictor unit 212 determines whether or not the not-yet-printed master image read out at Step S601 indicates using the C, M, Y, or K toner at a position corresponding to the position where the white line is detected (Step S606). If the master image indicates using the C, M, Y, or K toner at the position corresponding to the position where the white line is detected (Yes at Step S606), the predictor unit 212 predicts that a defect will be highly possibly detected again in restarting printing or, in short, a defect will be detected again (Step S604), then processing ends. On the other hand, if the master image indicates using none of the CMYK toners at the position corresponding to the position where the white line is detected (No at Step S606), processing proceeds to Step S609.

If the defect type is determined not to be white line (No at Step S605), the predictor unit 212 determines whether or not the type of the defect detected by the inspection unit 209 is dark line (Step S607). If the defect type is dark line (Yes at Step S607), the predictor unit 212 determines whether or not the not-yet-printed master image read out at Step S601 indicates using the K toner at a position corresponding to the position where the dark line is detected (Step S608). If the master image indicates not using the K toner at the position corresponding to the position where the dark line is detected (No at Step S608), the predictor unit 212 predicts that a defect will be highly possibly detected again in restarting printing or, in short, a defect will be detected again (Step S604), then processing ends. On the other hand, if the master image indicates using the K toner at the position corresponding to the position where the dark line is detected (Yes at Step S608), processing proceeds to Step S609. If the defect type is determined not to be dark line (No at Step S607), processing proceeds to Step S610.

The predictor unit 212 determines whether or not there is any not-yet-printed master image that is not processed yet (Step S609). If there is any not-yet-printed master image that is not processed yet (Yes at Step S609), processing returns to Step S601 to repeat Step S601 and the steps that follow Step S601. If there is no not-yet-printed master image that is not processed yet (No at Step S609), the predictor unit 212 predicts that a defect will be less likely detected again in restarting printing or, in short, a defect will not be detected again (Step S610), then processing ends.

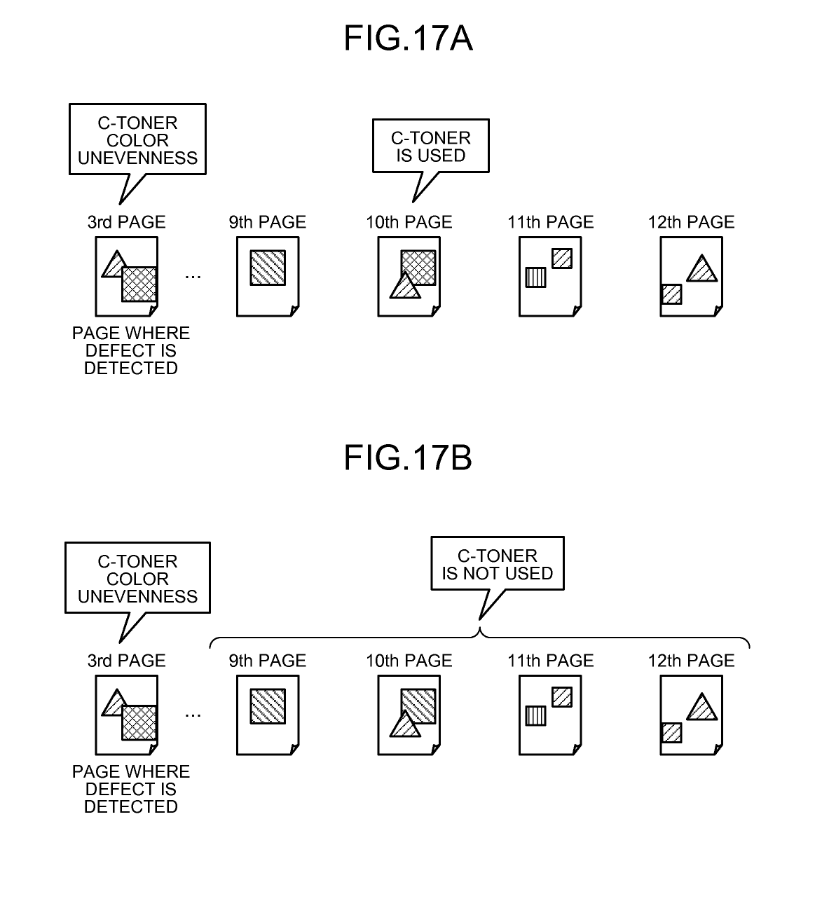

FIGS. 17A and 17B are schematic diagrams illustrating specific examples of processing performed by the predictor unit 212 in a situation where the type of the defect detected by the inspection unit 209 is C (cyan) color unevenness in the above-described example. In the example illustrated in FIG. 17A where the 9th to 12th pages are not-yet-printed master images, a not-yet-printed master image of the 10th page indicates using the C toner. Accordingly, the predictor unit 212 predicts that a defect will be detected again in restarting printing. In the example illustrated in FIG. 17B where the 9th to 12th pages are not-yet-printed master images, none of not-yet-printed master images indicates using the C toner. Accordingly, the predictor unit 212 predicts that a defect will not be detected again in restarting printing.

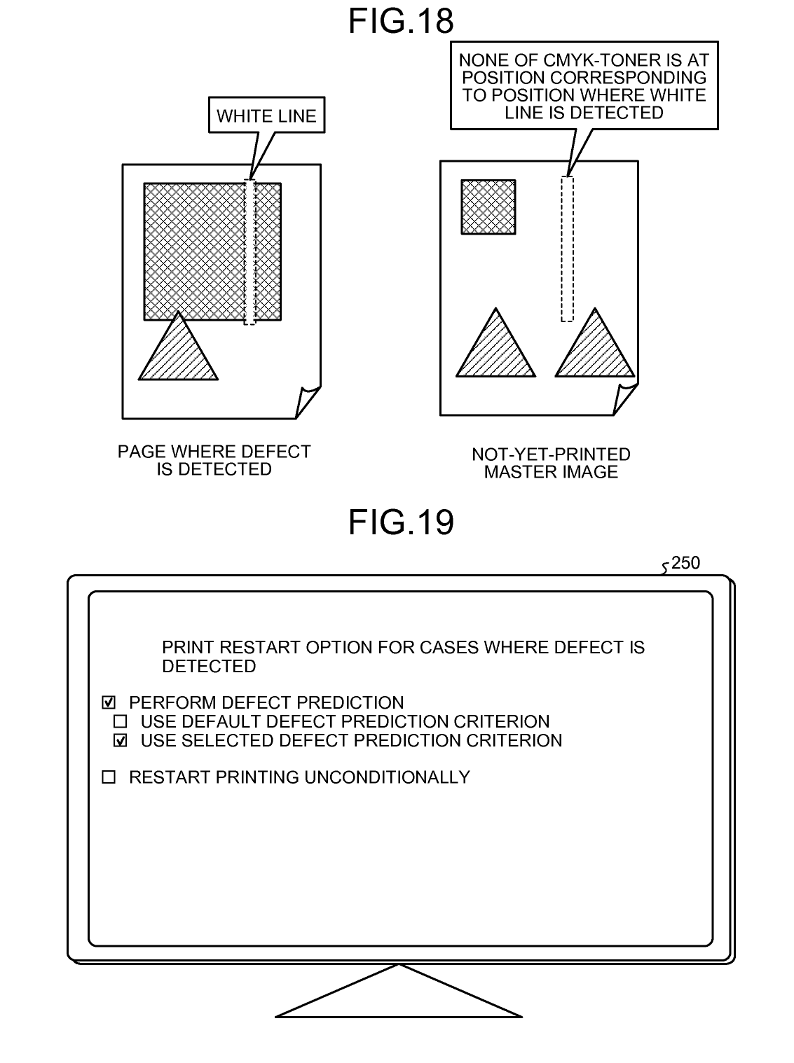

FIG. 18 is a schematic diagram illustrating a specific example of processing performed by the predictor unit 212 in a situation where the type of the defect detected by the inspection unit 209 is white line. If the type of the defect detected by the inspection unit 209 is white line, as illustrated in FIG. 18, the predictor unit 212 determines whether or not the C, M, Y, or K toner is used at a position corresponding to the position where the white line is detected for each of the not-yet-printed master images. The predictor unit 212 predicts that a defect will not be detected again in restarting printing if none of the not-yet-printed master images indicates using the C, M, Y, or K toner at the position corresponding to the position where the white line is detected. On the other hand, the predictor unit 212 predicts that a defect will be detected again in restarting printing if any one of the not-yet-printed master images indicates using the C, M, Y, or K toner at the position corresponding to the position where the white line is detected. When the type of the defect detected by the inspection unit 209 is dark line, the predictor unit 212 predicts that a defect will not be detected again in restarting printing if all of the not-yet-printed master images indicate that the K toner is to be used at a position corresponding to the position of the detected dark line, whereas predicts that defect will be detected again in restarting printing if any one of the not-yet-printed master images indicates that the K toner is not to be used at the position corresponding to the position of the detected dark line.

The specific examples of the print-restart prediction criterion have been described above. The predictor unit 212 predicts whether or not a defect will be detected again in restarting printing using one of or a combination of a plurality of these print-restart prediction criteria. The predictor unit 212 may be configured to use a print-restart prediction criterion having been set as a default setting or, alternatively, use a criterion selected by an operating input provided by an operator utilizing the operation panel 250.

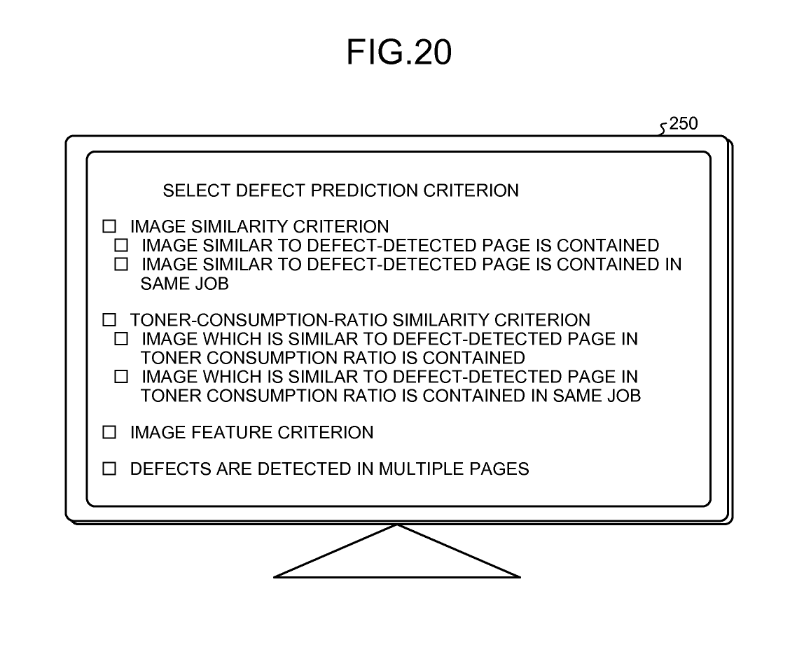

FIGS. 19 and 20 are diagrams illustrating examples of input screens on the operation panel 250 for receiving operating inputs selecting a print-restart prediction criterion. The operation panel 250 displays such an input screen as that illustrated in FIG. 19 to receive an operating input provided by an operator to select whether or not to make defect prediction. When defect prediction is made, the input screen further receives an operating input selecting either using a default defect prediction criterion or selecting a defect prediction criterion. Upon receiving an operating input requesting that defect prediction is made using a selected defect prediction criterion, the operation panel 250 displays such an input screen as that illustrated in FIG. 20 to receive an operating input selecting a defect prediction criterion provided by the operator. The input screen illustrated in FIG. 20 is configured to allow to select a combination of multiple defect prediction criteria.

As described above in detail by way of the specific examples, in the image forming system according to the present embodiment, the inspection apparatus 200 predicts whether or not a defect will be detected again in restarting printing using a master image of a page where a defect is detected, not-yet-printed master images, and a defect prediction criterion. The printer apparatus 100 is prohibited from restarting printing if it is predicted that a defect will be detected again in restarting printing. Accordingly, according to the image forming system, waste of printing paper and coloring materials which can occur in restarting printing can be effectively reduced.

Furthermore, the print-restart prediction criterion for use in predicting whether or not a defect will be detected again in restarting printing is operator-selectable using an operating input. Accordingly, prediction adapted to an actual printing environment can be made.

Furthermore, in a case where it is predicted that a defect will be detected again in restarting printing, a warning may preferably be displayed on the operation panel 250 or the like, thereby prompting an operator to take an appropriate action, such as cleaning or job cancellation.

Primary functions including the master-image generating unit 208, the inspection unit 209, the print-restart control unit 210 (the pause control unit 211, the predictor unit 212, the resumption control unit 213, and the calculator unit 214) of the inspection apparatus 200 can be implemented in a dedicated hardware element, such as an ASIC (application specific integrated circuit) or an FPGA (field-programmable gate array). These primary functions can alternatively be implemented by the system control unit 201 including a CPU (central processing unit) (processor), a RAM (random access memory) (main storage), and a ROM (read only memory) by executing predetermined program instructions. In this case, the program for implementing the primary functions described above can be provided as being stored on the ROM or the like in advance, for example. The program for implementing the primary functions may be configured to be provided as being recorded on a non-transitory computer-readable recording medium such as a CD-ROM (compact disc-read-only memory), a FD (flexible disk), a CD-R (compact disc recordable), or a DVD (digital versatile disk) in an installable or executable format.

The program for implementing the primary functions described above may be configured to be stored on a computer connected to a network such as the Internet and provided by being downloaded over the network. The program for implementing the primary functions described above may be configured to be provided or distributed over a network such as the Internet.

The program is made up of modules including the master-image generating unit 208, the inspection unit 209, the print-restart control unit 210 (the pause control unit 211, the predictor unit 212, the resumption control unit 213, and the calculator unit 214) of the inspection apparatus 200. From the viewpoint of actual hardware, the CPU (processor) reads out the program from the ROM or the like and executes the program to load the units described above into the RAM (main storage), thereby generating the units on the RAM (main storage).

According to an aspect of the present invention, restarting printing is prohibited when it is predicted that a defect will be detected again in restarting printing. Accordingly, waste of printing paper and coloring materials which can occur in restarting printing can be effectively reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An inspection apparatus for inspecting a printed product, the inspection apparatus comprising:
a generating unit configured to generate master images corresponding to the printed product containing multiple pages before the printed product is printed;
an inspection unit configured to inspect the printed product for a defect by comparing scanned images obtained by scanning the printed product with the master images;
a pause control unit configured to, when the inspection unit detects a defect in a page of the printed product while the printed product is continuously printed, cause printing to pause;
a predictor unit configured to, when the pause control unit causes printing to pause, predict whether or not a defect will be detected again in restarting printing by using one master image of the master images generated by the generating unit, the one master image being of a not-yet-printed page, a master image of the page where the defect is detected by the inspection unit, and a predetermined defect prediction criterion; and
a resumption control unit configured to permit to restart printing the page where the defect is detected by the inspection unit and pages following the defect-detected page if the predictor unit predicts that a defect will not be detected again in restarting printing, and prohibit from restarting printing the page where the defect is detected by the inspection unit and the pages following the defect-detected page if the predictor unit predicts that a defect will be detected again in restarting printing.

2. The inspection apparatus according to claim 1, further comprising
an input receiving unit configured to receive an operating input designating the defect prediction criterion, wherein
the predictor unit predicts whether or not a defect will be detected again in restarting printing using the defect prediction criterion designated by the operating input.

3. The inspection apparatus according to claim 1, wherein the defect prediction criterion is a criterion that at least one of not-yet-printed master images generated by the generating unit should have a similarity of a predetermined first threshold or higher with the master image of the page where the defect is detected by the inspection unit.

4. The inspection apparatus according to claim 1, further comprising
a calculator unit configured to calculate coloring-material consumption ratios of the printed product based on the master images, wherein
the defect prediction criterion is a criterion that a difference between a coloring-material consumption ratio calculated from at least one of the not-yet-printed master images generated by the generating unit and a coloring-material consumption ratio calculated from the master image of the page where the defect is detected by the inspection unit should be equal to or lower than a predetermined second threshold.

5. The inspection apparatus according to claim 1, wherein the defect prediction criterion is a criterion that at least one of the not-yet-printed master images generated by the generating unit should have an image feature having been determined in advance according to a type of a defect detected by the inspection unit.

6. The inspection apparatus according to claim 1, further comprising a display unit configured to display a warning if the predictor unit predicts that a defect will be detected again in restarting printing.

7. An image forming apparatus comprising:
a printing unit configured to performing printing to produce a printed product; and
the inspection apparatus according to claim 1.

8. An inspection method performed by an inspection apparatus for inspecting a printed product, the inspection method comprising:
generating, by a generating unit, master images corresponding to the printed product containing multiple pages before the printed product is printed;
inspecting, by an inspection unit, the printed product for a defect by comparing scanned images obtained by scanning the printed product with the master images;
causing, by a pause control unit, printing to pause if the inspection unit detects a defect in a page of the printed product while the printed product is continuously printed;
when the pause control unit causes printing to pause, predicting, by a predictor unit, whether or not a defect will be detected again in restarting printing by using one master image of the master images generated by the generating unit, the one master image being of a not-yet-printed page, a master image of the page where the defect is detected by the inspection unit, and a predetermined defect prediction criterion; and
permitting, by a resumption control unit, restarting printing of the page where the defect is detected by the inspection unit and pages following the defect-detected page if the predictor unit predicts that a defect will not be detected again in restarting printing, and prohibiting, by the resumption control unit, from restarting printing the page where the defect is detected by the inspection unit and the pages following the defect-detected page if the predictor unit predicts that a defect will be detected again in restarting printing.

9. A non-transitory computer-readable storage medium having computer-executable instructions stored thereon which, when executed by a processor included in an inspection apparatus for inspecting a printed product, cause the inspection apparatus to implement functions comprising:
generating, by a generating unit, master images corresponding to the printed product containing multiple pages before the printed product is printed;
inspecting, by an inspection unit, the printed product for a defect by comparing scanned images obtained by scanning the printed product with the master images;
causing, by a pause control unit, printing to pause when a defect is detected by the inspection unit in a page of the printed product while the printed product is continuously printed;
when the pause control unit causes printing to pause, predicting, by a predictor unit, whether or not a defect will be detected again in restarting printing by using one master image of the master images generated by the generating unit, the one master image being of a not-yet-printed page, a master image of the page where the defect is detected by the inspection unit, and a predetermined defect prediction criterion; and
permitting, by a resumption control unit, to restart printing the page where the defect is detected by the inspection unit and pages following the defect-detected page if the predictor unit predicts that a defect will not be detected again in restarting printing, and prohibiting, by the resumption control unit, from restarting printing the page where the defect is detected by the inspection unit and the pages following the defect-detected page if the predictor unit predicts that a defect will be detected again in restarting printing.
